(19) United States
(12) Patent Application Publication
(10) Pub. No.: US 2010/0129495 A1
(43) Pub. Date: May 27, 2010

(54) SERUM CHOLESTROL-LOWERING MATERIAL, PROCESS FOR PRODUCING SAME

(76) Inventors: Mamoru Kimura, Ibaraki (JP); Yasunobu Masuda, Tokyo (JP); Yuji Ogino, Ibaraki (JP)

Correspondence Address: Joseph J. Crimaldi;Roetzel & Andress, 222 S. Main St., Akron, OH, 44308, US

(21) Appl. No.: 11/816,014

(22) PCT Filed: Feb. 23, 2006
(86) PCT No.: PCT/JP2006/303262

§ 371 Date: Aug. 12, 2009

(30) Foreign Application Priority Data
Feb. 28, 2005 (JP) JP2005053380

(51) Int. Cl. A23L 1/32

(52) U.S. Cl. 426/61

(57) ABSTRACT

The serum cholesterol-lowering material of the invention contains lactic acid-fermented egg white. The food composition having a serum cholesterol-lowering effect of the invention contains a serum cholesterol-lowering material. The pharmaceutical composition having a serum cholesterol-lowering effect of the invention contains a serum cholesterol-lowering material as an active component. The process for producing the serum cholesterol-lowering material of the invention comprises adding lactobacillus to an aqueous solution containing the egg white and fermenting the egg white.

### TECHNICAL FIELD

The present invention relates to a serum cholesterol-lowering material comprising lactic acid-fermented egg white, process for producing the same, and a food composition and a pharmaceutical composition having a serum cholesterol-lowering effect.

### BACKGROUND ART

In recent years, it has been made clear that the elevation of serum cholesterol caused by living habits such as eating habits, stress and the like has been the trigger for serious cardiovascular diseases such as arteriosclerosis and ischemic heart disease. This is becoming a big social problem.

A dietary treatment that reduces lipid intake and improves the omega 3/omega 6 balance and a dietary treatment that controls dietary cholesterol are recommended. For example, a method for intaking lactobacillus as live bacteria is disclosed in JP-A-2002-65203. JP-A-2003-306436 discloses an inhibitor for elevation of serum cholesterol having a lactobacillus culture as an active ingredient. In other words, the above-mentioned documents disclose the lowering of serum cholesterol by culturing lactobacillus by a specific medium and intaking the obtained live bacteria or culture solution thereof.

However, since there is no habit of intaking a bacterium or a culture solution, the idea of constantly consuming them makes the consumer feel uneasy. Furthermore, although fermented milk obtained by lactic fermentation or the use of yeast is widely known as a food, the application of fermented milk to a food is limited due to its characteristic odor. Some consumers dislike the flavor of fermented milk. Thus, general application of fermented milk in food products is not as popular as desired.

### DISCLOSURE OF THE INVENTION

An object of the invention is to provide a serum cholesterol-lowering material containing lactic acid-fermented egg white, which can lower the serum total cholesterol without lowering the serum high-density lipoprotein cholesterol, imparts an excellent flavor, and does not impair the flavor of food when mixed with the food.

Another object of the invention is to provide a food composition and a pharmaceutical composition having a serum cholesterol-lowering effect comprising the serum cholesterol-lowering material.

As a result of extensive studies on the physiological mechanism of lactic acid fermented product of egg white in order to achieve the above objects, the inventors have surprisingly and unexpectedly found that a composition which can significantly lower serum total cholesterol without lowering serum high-density lipoprotein cholesterol, and having an excellent flavor can be obtained. This finding has led to the completion of the invention.

(1) A serum cholesterol-lowering material of the invention comprises lactic acid-fermented egg white.

In the serum cholesterol-lowering material of the invention, the lactic acid-fermented egg white can be obtained by fermenting a solution by adding lactobacillus to an aqueous solution containing egg white and a lactobacillus-assimilating saccharide.

(2) A food composition having a serum cholesterol-lowering effect of the invention comprises the serum cholesterol-lowering material of the invention.
(3) A pharmaceutical composition having a serum cholesterol-lowering effect of the invention comprises the serum cholesterol-lowering material of the invention as an active component.
(4) A process for producing the serum cholesterol-lowering material of the invention comprises adding lactobacillus to an aqueous solution containing egg white and a lactobacillus-assimilating saccharide, and fermenting the solution.

In the process for producing the serum cholesterol-lowering material of the invention, the above-mentioned aqueous solution may be heated prior to fermentation.

In the process for producing the serum cholesterol-lowering material of the invention, the fermented product may be homogenized.

In the above process for producing the serum cholesterol-lowering material, the aqueous solution may further comprise 0.05 to 5% by mass of egg yolk.

Due to inclusion of lactic acid-fermented egg white, the serum cholesterol-lowering material of the invention can lower the serum total cholesterol without lowering the serum high-density lipoprotein cholesterol. In addition, due to the property of imparting an excellent flavor, a useful high cholesterol improvement material can be obtained. A food composition or a pharmaceutical composition which is edible or ingested with ease can be obtained by using the serum cholesterol-lowering material of the invention.

The food composition and pharmaceutical composition of the invention are highly safe, have an excellent texture and flavor, and exhibit an excellent serum cholesterol-lowering effect. Hyperlipemia can be prevented or improved by eating or ingesting the food composition or pharmaceutical composition of the invention.

### BEST MODE FOR CARRYING OUT THE INVENTION

The invention will now be explained. In the invention, “%” indicates “% by mass”.

### 1. SERUM CHOLESTEROL-LOWERING MATERIAL AND PROCESS FOR PRODUCING SAME

### 1.1. Serum Cholesterol-Lowering Material

The serum cholesterol-lowering material of the invention contains lactic acid-fermented egg white. That is, the lactic acid-fermented egg white can be used as a serum cholesterol-lowering material. In the invention, the lactic acid-fermented egg white can be obtained by fermenting a solution by adding lactobacillus to an aqueous solution containing the egg white and a lactobacillus-assimilating saccharide.

The lactic acid-fermented egg white has an effect of significantly lowering serum total cholesterol (TC) without lowering the serum high-density lipoprotein-cholesterol (HDL-C). In addition, lactic acid-fermented egg white is considered to exhibit an effect of accelerating excretion of cholesterol in the body by changing the cholesterol into bile acid. Moreover, the lactic acid-fermented egg white has a good texture, is delicious, and has little odor peculiar to eggs.

In the invention, egg white is a material obtainable by cracking an egg of a bird such as a hen and removing the egg yolk, and includes industrially available egg white, egg white obtained by sterilizing, freezing, condensing, or diluting the industrially available egg white, a product obtained by removing specific components such as lysozyme and avidin, and a product obtained by hydrating dried egg white, and the like. The egg white may contain egg yolk or other components of egg origin to an extent not affecting the effect of the invention.

In the invention, lactic acid fermentation is an operation of fermenting a material by adding 10³ to 10⁸, and preferably 10⁵ to 10⁷ lactobacillus, per 1 mL of the material to be fermented. The lactobacillus used here is not particularly limited and includes, for example, lactobacillus belonging to genus Lactobacillus (for example, Lactobacillus bulgaricus), genus Streptococcus (for example, Streptococcus thermophilus and Streptococcus diacetylactis), genus Lactococcus (for example, Lactococcus lactis), genus Leuconostoc (for example, Leuconostoc cremoris), and genus Enterococcus (for example, Enterococcus faecalis).

Although the action mechanism of the effect of lactic acid-fermented egg white of significantly lowering serum total cholesterol without lowering the serum high-density lipoprotein-cholesterol is not clear, the lactic acid-fermented egg white does exhibit the effect of accelerating cholesterol metabolism when intaken. In particular, it is guessed that the decomposed materials generated in the lactic acid fermentation process of egg white may have an effect of lowering serum cholesterol.

On the other hand, a method for reducing or removing cholesterol by ingestion of lactobacillus is disclosed in JP-A-2002-65203, for example. According to the disclosure of this patent application, the cholesterol reduction by ingestion of lactobacillus is thought to be the result of adsorption or incorporation of cholesterol into cells of the microorganism. In addition, JP-A-2003-306436 discloses a method for inhibiting an increase of serum cholesterol by ingestion of lactobacillus. According to the description of the patent application, an increase of cholesterol in serum is thought to be controlled by ingestion of lactobacillus by the action of the cells to inhibit cholesterol absorption into the intestinal tract and to adsorb cholesterol and bile acid and excretion them from the body.

That is, it is though that due to the effect of adsorbing (or bonding to) cholesterol, both living and dead cells of lactobacillus prevent absorption of cholesterol into the body and excretion cholesterol into the feces, thereby exhibiting a cholesterol-lowering action.

In contrast, reduction of serum cholesterol by ingestion of lactic acid-fermented egg white according to the invention is thought to be mainly the result of acceleration of cholesterol metabolism due to change of cholesterol into bile acid in the body. This presumption is based on the results of the experiment shown in Table 5 later in this specification, showing that the amount of the excreted bile acid was larger in the fermented egg white group (the group which ingested lactic acid-fermented egg white) than in the control group (the group which did not ingest lactic acid-fermented egg white).

That is, it is believed that the serum cholesterol reduction by ingestion of lactic acid-fermented egg white is caused by a mechanism differing from the mechanism of cholesterol reduction by ingestion only of lactobacillus.

The serum cholesterol-lowering material of the invention can take various forms such as a micro colloid, a powder, a cream, a paste, or a jelly. Namely, the serum cholesterol-lowering material can be obtained in various forms by appropriately processing lactic acid-fermented egg white according to the use.

For example, lactic acid-fermented egg white in the form of a micro colloid can be obtained by fermenting egg white by adding lactobacillus to an aqueous solution containing egg white and lactobacillus-assimilating saccharides (described later in more detail). The lactic acid-fermented egg white can be homogeneously dispersed in a food composition or a pharmaceutical composition by preparing the later-described food composition or pharmaceutical composition using the lactic acid-fermented egg white in the form of a micro colloid.

If the lactic acid-fermented egg white in the form of a micro colloid is dried (by means of freeze-drying, spray drying, or vacuum drying, for example), the lactic acid-fermented egg white of the invention can be obtained as a powder. Powdered lactic acid-fermented egg white is easy to handle due to its light weight. In addition, lactic acid-fermented egg white can be homogeneously dispersed in a food composition or a pharmaceutical composition by adding the powdered lactic acid-fermented egg white.

The serum cholesterol-lowering material of the present invention can be used as one of the components of food, medical supplies, feed, and the like or may be used, as is, as food, medical supplies, feed, or the like.

That is, the serum cholesterol-lowering material of the invention can be used as a component of food compositions or pharmaceutical compositions described later. In addition, since the lactic acid-fermented egg white of the invention has little odor peculiar to eggs and a good texture, and is delicious as mentioned above, the lactic acid-fermented egg white neither imparts a wrong feeling in its smell or texture during ingestion nor damages the flavor of other components when used as a component of a food composition or a pharmaceutical composition which is mentioned later.

There are no limitations to the pH of the food composition or pharmaceutical composition in which the serum cholesterol-lowering material of the invention can be used. The food composition or pharmaceutical composition comprising the serum cholesterol-lowering material of the invention can be ingested by humans or other animals.

### 1.2. Process for Producing Serum Cholesterol-Lowering Material

The process for producing the serum cholesterol-lowering material comprises adding lactobacillus to an aqueous solution containing the egg white and lactobacillus-assimilating saccharides, and fermenting the solution. Lactic acid-fermented egg white can be obtained in this manner.

The lactic acid fermentation temperature is preferably in a range of 25 to 50° C., and more preferably an optimal culture temperature of the specific lactobacillus used. The degree of lactic acid fermentation, in terms of the lactic acid acidity at the end of fermentation, is preferably 0.3 to 2%.

The fermentation efficiency can be improved by adding a lactobacillus-assimilating saccharide when egg white is fermented by lactic acid. As examples of the lactobacillus-assimilating saccharide, monosaccharides (e.g. glucose, galactose, fructose, mannose, or N-acetylglucosamine), disaccharides (lactose, maltose, sucrose, cellbiose, or trehalose), oligosaccharides (particularly an oligosaccharide in which 3 to 5 monosaccharides are combined), and high fructose corn syrup can be given. These lactobacillus-assimilating saccharides may be used either individually or in combination of two or more. The amount of the lactobacillus-assimilating saccharides to be added is preferably 1 to 15%, and more preferably 2 to 10%, of the amount of the aqueous solution. If less than 1%, the fermentation may not sufficiently proceed due to lack of the lactobacillus-assimilating saccharide. If more than 15%, it may be difficult for the fermentation to proceed sufficiently due to an increase in osmotic pressure.

Moreover, the aqueous solution containing egg white and a lactobacillus-assimilating saccharide may further contain 0.05 to 5% by mass, and preferably 0.5 to 2% by mass, of egg yolk. The amount of egg yolk in the range of 0.05 to 5% by mass in the aqueous solution can further increase lactic acid fermentation. If the amount of egg yolk is more than 5% by mass, the flavor may be impaired. An amount of egg yolk less than 0.05% by mass may not be sufficient to promote lactic fermentation.

The lactic acid fermentation can also be carried out by adding another fermentation promoting material to the above-mentioned aqueous solution. As such a fermentation promoting material, any material containing a component that can promote fermentation, for example, vitamins (nicotinic acid, pantothenic acid, biotin, etc.), an amino acid, or a nucleic acid can be used without particular limitation. As examples of the fermentation promoting material, yeast extract, meat extract, casein hydrolyzate, vitamins, coenzymes, and minerals can be given.

Furthermore, the method may further comprise a step of heating the aqueous solution containing egg white and a lactobacillus-assimilating saccharide prior to the fermentation. Heating can deactivate microorganism growth factors (factors which control growth and/or fermentation of lactobacillus).

Such a heating temperature is preferably 60 to 110° C., and more preferably 70 to 95° C. If the temperature is lower than 60° C., deactivation of microorganism growth inhibitors which exist in egg white may be insufficient, leading to insufficient fermentation. If the temperature is higher than 110° C., thermal denaturation may progress excessively, making it difficult to industrially apply the method due to browning or burning.

The egg white can be denatured by heating at a temperature, for example of, 60 to 110° C. for 10 to 60 minutes. Here, denaturation of egg white with heating refers to an operation to effect a change in the properties of the egg white, for example, aggregation, coagulation, or the like of egg white. The higher the temperature, the shorter may be the heating time. Denaturation of egg white with heating has an effect of deactivating lactobacillus growth inhibitors such as lysozyme and promoting smooth lactic acid fermentation.

The method may further comprise the homogenizing fermented product. “Homogenizing” in the invention refers to an operation of obtaining a fermented product by lactic acid fermentation of an aqueous solution containing egg white and a lactobacillus-assimilating saccharide, and homogeneously dispersing the components in the fermentated product by applying an external physical force.

Although not specifically limited, processing by a strainer, stirring using a pump, and pressurization using a high-pressure homogenizer can be given as examples of the method for applying an external physical force. Of these, pressurization and crushing using a high-pressure homogenizer is industrially preferable, in which a pressure of preferably 10 to 80 MPa, and more preferably 30 to 60 MPa is applied.

The average particle diameter of the lactic acid-fermented egg white obtained by the homogenizing treatment is preferably 30 micrometers or less, and more preferably 15 micrometers or less. An average particle diameter of not more than 30 micrometers ensures homogeneous dispersion of the lactic acid-fermented egg white in a food composition or a pharmaceutical composition and production of a product with a smooth texture.

A typical process for producing the serum cholesterol-lowering material of the invention will now be described. 2 to 8% egg white protein, 1 to 15% lactobacillus-assimilating saccharide, and 0.5 to 10% of a fermentation promoting material are added to water, and the mixture is adjusted pH to 5 to 7.5 using lactic acid. After heating the resulting solution at 60 to 110° C. for 10 minutes, a lactobacillus starter containing Lactobacillus bulgaricus and Streptococcus Thermophilus is added in an amount of 10⁵ to 10⁷ cells/mL, followed by fermentation at 25 to 50° C. for 8 to 48 hours. After completion of fermentation, the fermented product is homogenized under a high pressure. Specifically, the fermented product is homogenized under a pressure of 10 to 80 MPa to obtain a creamy lactic acid-fermented egg white.

### 2. FOOD COMPOSITION

The food composition having a serum cholesterol-lowering effect of the invention (hereinafter referred to from time to time as “food composition”) contains a serum cholesterol-lowering material. That is, the food composition of the invention contains lactic acid-fermented egg white. The form of the lactic acid-fermented egg white added to the food composition of the invention can be appropriately selected according to the use.

Although not particularly limited, the food composition of the invention can be a processed food, for example. As examples of the processed food, confectionery, processed products of legumes, mayonnaise, dressings, dairy products (e.g. milk beverages, fermented milk, lactic acid bacteria beverages, lactic acid bacteria dairy drinks), processed egg products, prepared foods, and drinks (soft drinks, etc.) can be given.

In addition, a food preparation (a supplement) can be prepared by using the food composition of the invention as an active component. In this instance, the food preparation may be provided in a form such as a powder, a tablet, a capsule, or a liquid (a health drink, etc.) by adding various food materials or drink materials. In addition, a base material, an excipient, an additive, a submaterial, an extender, and the like may be added as appropriate to the food preparation.

The food composition of the present invention may be ingested either while eating a food containing cholesterol, or before or after eating the food containing cholesterol. Or, it is possible to eat the food composition before ingesting a food containing cholesterol either alone or by mixing with the food containing cholesterol.

### 3. PHARMACEUTICAL COMPOSITION

The pharmaceutical composition having a serum cholesterol-lowering effect of the invention (hereinafter referred to from time to time as “pharmaceutical composition”) contains a serum cholesterol-lowering material as an active component. That is, the pharmaceutical composition having a serum cholesterol-lowering effect of the invention contains the serum cholesterol-lowering material as an active component.

Although not particularly limited, the pharmaceutical composition of the invention can be administered by oral administration, injection, or the like, for example. The composition may be administered before a meal, after a meal, or between meals once a day or several times a day.

Although the form of the composition is not particularly limited, the pharmaceutical composition of the invention can be an orally administered agent. For example, a material containing the serum cholesterol-lowering material of the present invention mentioned above can be processed into the preparations given below.

As examples of the orally administered agent, internal agents such as a tablet preparation, a capsule preparation, a powder preparation, a subtle granule preparation, a granule preparation, a liquid preparation, a syrup preparation, and a drinking preparation can be given. In this instance, the pharmaceutical composition of the invention may contain a binder, an excipient, a swelling agent, a lubricant, a sweetener, a flavor agent, and the like, together with the serum cholesterol-lowering material of the invention. The tablet preparation may be coated with shellac or sugar. The capsule preparation may contain a liquid carrier such as fats and oils in addition to the above-mentioned materials. The syrup preparation and a drink preparation may contain a sweetener, an antiseptic agent, a coloring flavor agent, and the like.

### 4. EXAMPLES

The invention is described below in more detail by way of examples and experimental examples. However, the invention is not limited to these examples. The particle size of micro colloidal lactic acid-fermented egg white was determined by the following method.

Measuring method: The particle size and the particle size distribution were analyzed from the light intensity distribution pattern of diffraction/dispersion light when particles are irradiated with laser beam.

Measuring device: Shimazu laser diffraction particle size distribution analyzer, SALD-200V™ (manufactured by Shimadzu Corp.)

### 4.1. Example 1

A cream-like mix was prepared by stirring 3 kg of an aqueous phase consisting of 34% liquid egg white, 6% sucrose, 0.5% egg yolk, 0.05% yeast extract, 0.15% of 50% lactic acid, and 59.3% water. After heating the resulting cream-like mix at 75° C. for 10 minutes, 0.01% of a lactobacillus starter (Lactobacillus bulgaricus, Streptococcus Thermophilus) was added. The mixture was fermented at 42° C. for 24 hours, followed by pasteurization by heating at 70 to 90° C., to obtain a fermented product containing a yoghurt-like perfume component with a 4.2 pH. This lactic acid acidity was 0.7%. The fermented product was pressurized and crushed under a pressure of 30 MPa using a high-pressure homogenizer to obtain a micro colloidal lactic acid-fermented egg white with an average particle size of 0.1 to 2.0 micrometers.

### 4.2. Example 2

A cream-like mix was prepared by stirring 3 kg of an aqueous phase consisting of 50% liquid egg white, 9% high fructose corn syrup, 0.05% yeast extract; 0.5% skimmed milk powder, 0.15% of 50% lactic acid, and 40.3% water. After heating the resulting cream-like mix at 75° C. for 10 minutes, 0.01% of a lactobacillus starter (Lactococcus lactis subsp. Lactis, Leuconostoc mesenteroides subsp. Cremoris, Streptococcus diacetylactis, Lactococcus lactis subsp. cremoris) was added. The mixture was fermented at 30° C. for 24 hours, followed by pasteurization by heating at 70 to 90° C., to obtain a fermented product containing a sour cream-like perfume component with 4.2 to 4.5 pH. This lactic acid acidity was 0.6%. The fermented product was pressurized and crushed under a pressure of 50 MPa using a high-pressure homogenizer to obtain a micro colloidal lactic acid-fermented egg white with an average particle size of 0.1 to 2.0 micrometer.

### 4.3. Experimental Example 1

Next, the lactic acid-fermented egg white obtained in Example 1 was freeze-dried and presented as a sample of an animal experiment to confirm a serum cholesterol improvement effect. The experimental method, evaluation criteria, measuring method, and experimental results were as follows.

### 4.3.1. Experimental Method

### 4.3.1-1. Experimental Animal

Wistar rats: male, aged six weeks (at the time of feeding experimental diet), purchased from Japan SLC, Inc.

### 4.3.1-2. Experimental Sample

Lactic acid-fermented egg white: Lactic acid-fermented egg white obtained in Example 1 was freeze dried (drying loss: 2.4%), and used for the experiment.

### 4.3.1-3. Experimental Groups

(A) Control group: A group to which a diet containing 20% casein was fed (five animals)
(B) Fermented egg white group: A group to which a diet containing 10% lactic acid-fermented egg white and 16.1% casein was fed (five animals)

The diets used in (A) control group and (B) fermented egg white group were adjusted to have the same protein content using casein and beta-cornstarch.

### 4.3.1-4. Experimental Diet Composition

The experimental diet compositions are shown in Table 1. as a lipid 5% lard and 2% soybean oil were added to the diet in accordance with the AIN-93G composition. In addition, 1% cholesterol and 0.25% sodium cholate were added to make the diet more susceptible to elevation of serum cholesterol concentration.

The control diet contained 20% casein as protein. The fermented egg white diet containing 10% lactic acid-fermented egg white and its casein content was adjusted to have the same protein content as the control diet. The whole combination was adjusted with beta-cornstarch. A diet having the same composition as the control diet, but not containing cholesterol and sodium cholate, was used as a basal diet.

TABLE 1
Experimental diet Composition

| | Basal | Control | Fermented egg |
|---|---|---|---|
| | diet (%) | diet (%) | white diet (%) |
| Casein | 20.00 | 20.00 | 16.12 |
| Lactic acid-fermented egg white | — | — | 10.00 |
| Alfa-cornstarch | 13.20 | 13.20 | 13.20 |
| Beta-cornstarch | 40.05 | 38.80 | 32.68 |
| Sucrose | 10.00 | 10.00 | 10.00 |
| Lard | 5.00 | 5.00 | 5.00 |
| Soybean oil | 2.00 | 2.00 | 2.00 |
| Cellulose | 5.00 | 5.00 | 5.00 |
| Mineral mixture (AIN-93G) | 3.50 | 3.50 | 3.50 |
| Vitamins mixture (AIN-93) | 1.00 | 1.00 | 1.00 |
| Choline bitartrate | 0.25 | 0.25 | 0.25 |
| t-Butylhydroquinone | 0.0014 | 0.0014 | 0.0014 |
| Cholesterol | — | 1.00 | 1.00 |
| Sodium cholate | — | 0.25 | 0.25 |
| Total | 100.00 | 100.00 | 100.00 |
| Energy (kcal/100 g) | 364.6 | 360.2 | 361.9 |

Protein content: Casein: 84% (manufactured by Oriental Yeast Co., Ltd., analytical value)
Fermented egg white 33% (analytical value)

### 4.3.1-5. Experimental Procedure

The rats were bred in individual cages for two days after delivery to cause them to become acclimated to the environment. In the meantime, the animals were fed with a commercially available pellet diet (PMI Nutrition International Lab. Diet™ 5002). After two days, the pellet diet was switched to the basal diet in order to habituate the animals to powder diet. After feeding the basal diet for 11 days, the animals were divided into two groups, each consisting of animals having the same average weight, whereupon the diet was switched to the experimental diet. After allowing the animals to free access to eat the experimental diet and drink water for three weeks, the animals were fasted for 12 hours, from 21:00 PM to 9:00 AM, whereupon blood was collected from abdominal vein under anesthesia with sodium pentobarbital (Nembutal™ manufactured by Dainippon Pharmaceutical Co., Ltd.). The blood was centrifuged at 3,000 rpm for 30 minutes at 4° C. and the collected serum was used for analysis.

Excrement was collected for three days from the 18th day through the 21st day from the start of feeding the experimental diet and used for lipid analysis after freeze drying.

### 4.3.2. Evaluation Items and Measuring Method

### 4.3.2-1. Evaluation Items

Body Weight, food consumption, feed efficiency, serum lipid (total cholesterol (TC)) concentration, high-density lipoprotein cholesterol (HDL-C) concentration, and triglyceride (TG) concentration, lipid in excrement (dry weight, amount of bile acid excretion, amount of neutral sterol excretion) were measured and evaluated.

### 4.3.2-2. Measuring Method of Serum Lipid Concentration

The serum lipid concentration was measured using the following kits.

TC concentration: Determiner TC555™ (manufactured by Kyowa Medex Co., Ltd.)
HDL-C concentration: HDL Cholesterol E-Test Wako™ (manufactured by Wako Pure Chemical Industries, Ltd.)
TG concentration: Triglyceride E-Test Wako™ (manufactured by Wako Pure Chemical Industries, Ltd.)

### 4.3.2-3. Measuring Method of Amount of Lipid in Excrement

The amount of lipid in excrement was measured using the following kits.

Amount of bile acid excretion: Total bile acid-Test Wako™ (manufactured by Wako Pure Chemical Industries, Ltd.)
Amount of neutral sterol excretion: Measured by gas chromatography after saponification.

The measuring device, column, and conditions used in gas chromatographic analysis were as follows.

Apparatus: G-500 type Hitachi gas chromatograph (manufactured by Hitachi, Ltd.)
Column: G-205 40 m, Df 0.1 micrometers
Rate of temperature rise: 250 to 270° C.

The total amount of the mass of cholesterol and the mass of coprostanol (intestinal bacterial metabolite of cholesterol) was calculated as the amount of neutral sterol excretion.

### 4.3.2-4. Evaluation Method

Each measured value was indicated by a mean value±standard deviation (SD).

Student's t-test was carried out for measured values between the control group and the fermented egg white group. When a significant difference was observed, an asterisk (*) was attached between the groups in each Table. Any evaluation item was judged to have a significant difference when p<0.05.

A statistical work program Dr. SPSS II for Windows™ (a product of SPSS Inc.) was use in the t-test.

### 4.3.3. Experimental Result

### 4.3.3-1. Body Weight and Food Consumption

The body weight and the amount of body weight increase are shown in Table 2, and the amount of food consumption and the feed efficiency are shown in Table 3.

According to Tables 2 and 3, no significant difference in the body weight and the amount of body weight increase was seen between the two groups.

TABLE 2
Body weight and body weight increase

| | Body weight | Body weight | |
|---|---|---|---|
| | at start of | after completion | Body weight |
| | experiment (g) | of experiment (g) | increase (g/day) |
| Control group | 135.2 ± 16.6 | 239.0 ± 18.2 | 4.9 ± 0.2 |
| Fermented egg | 136.9 ± 17.6 | 236.9 ± 16.0 | 4.8 ± 0.4 |
| white group | | | |

Value: Average value ± Standard deviation (SD)

TABLE 3
Feed intake amount and Feed efficiency

| | Feed intake (g/day) | Feed efficiency (%) |
|---|---|---|
| Control group | 16.5 ± 1.1 | 30.0 ± 1.5 |
| Fermented egg white group | 16.5 ± 1.0 | 28.8 ± 1.1 |

Value: Average value ± Standard deviation (SD)

### 4.3.3-2. Serum Lipid

The results of measurement of the serum lipid are shown in Table 4. It can be seen according to Table 4 that the TC concentration of the fermented egg white group was significantly lower than that of the control group (p=0.029). No significant difference was seen in the HDL-C concentration and the TG concentration between the two groups.

TABLE 4
Serum lipid

| | TC concen- | HDL-C concen- | TG concen- |
|---|---|---|---|
| | tration | tration | tration |
| | (mg/100 mL) | (mg/100 mL) | (mg/100 mL) |
| Control group | 210.0 ± 41.5 * | 32.1 ± 16.0 | 77.8 ± 11.0 |
| Fermented egg | 152.0 ± 32.2 * | 32.0 ± 19.6 | 79.2 ± 14.2 |
| white group | | | |

Value: Average value ± Standard deviation (SD)
* Significant difference with a risk rate of 5%

### 4.3.3-3. Bile Acid and Neutral Sterol Excretion to Excrement

The dry weight of excrement, the amount of bile acid excretion, and the amount of neutral sterol excretion are shown in Table 5. According to Table 5, although there was no significant difference in the dry weight of excrement, the amount of bile acid excretion, and the amount of neutral sterol excretion between the two groups, the amount of bile acid excretion was higher in the fermented egg white group than in the control group.

TABLE 5
Amount of dried excrement, bile acid excretion,
and neutral sterol excretion

| | | Bile acid | Neutral |
|---|---|---|---|
| | Dried excrement | excretion | sterol excretion |
| | (g/day) | (micromole/day) | (micromole/day) |
| Control group | 1.48 ± 0.12 | 85.8 ± 15.2 | 271.3 ± 21.7 |
| Fermented egg | 1.50 ± 0.12 | 101.6 ± 11.6 | 267.5 ± 16.2 |
| white group | | | |

Value: Average value ± Standard deviation (SD)

Based on the above results, it can be understood that the diet given to the animals of the fermented egg white group can lower the serum total cholesterol more effectively than the diet given to the control group, without lowering the serum high-density lipoprotein-cholesterol.

### 4.4. Application Example 1

The lactic acid-fermented egg white obtained in Example 1 in the form of micro colloid was freeze-dried, mixed with an appropriate amount of lactose, and formed into tablets using a tableting machine to obtain a pharmaceutical composition.

### 4.5. Application Example 2

A sugar coating was applied to the tablets obtained in Application Examples 1 using a coating pan to obtain a sugar coated tablet-type food for high serum cholesterol.

### 4.6. Application Example 3

A drink containing the lactic acid-fermented egg white prepared in Example 1 was prepared according to the following formulation.

### (Formulation)

Lactic acid-fermented egg white: 5%
Grapefruit juice (from concentrate): 10%
High fructose corn syrup: 8%

### Sweetener: 0.1%

### Acidulant: 0.2%

Viscosity increase stabilizer: 0.1%
Grapefruit fruit perfume: 0.1%

Water was added to the above components to make the total mass 100%. The resulting product was hot-packed (at 95° C.) in a 125 mL glass bottle, and the bottle was sealed and cooled, to obtain a drink formulated with the lactic acid-fermented egg white. A sample of the drink formulated with the lactic acid-fermented egg white of this Application Example was tasted to confirm that the drink possessed good flavor and excellent texture.

1. A serum cholesterol-lowering material comprising lactic acid-fermented egg white.

2. The serum cholesterol-lowering material according to claim 1, wherein the lactic acid-fermented egg white is obtained by fermenting egg white by adding lactobacillus to an aqueous solution containing egg white and a lactobacillus-assimilating saccharide.

3. A food composition having a serum cholesterol-lowering effect comprising the serum cholesterol-lowering material according to claim 1.

4. A pharmaceutical composition having a serum cholesterol-lowering effect comprising the serum cholesterol-lowering material according to claim 1 as an active component.

5. A process for producing a serum cholesterol-lowering material comprising adding lactobacillus to an aqueous solution containing egg white and a lactobacillus-assimilating saccharide, and fermenting the solution.

6. The process for producing a serum cholesterol-lowering material according to claim 5, wherein the aqueous solution is heated prior to fermentation.

7. The process for producing a serum cholesterol-lowering material according to claim 5, further comprising homogenizing the fermented product.

8. The process for producing a serum cholesterol-lowering material according to claim 5, wherein the aqueous solution further comprises 0.05 to 5% by mass of egg yolk.
